(19) United States
(12) Patent Application Publication
(10) Pub. No.: US 2024/0296137 A1
(43) Pub. Date: Sep. 5, 2024

(54) TECHNIQUES TO IMPROVE DEVICE SCALABILITY USING A PEER-TO-PEER PROTOCOL OVER A COMMUNICATION LINK

(71) Applicant: Intel Corporation, Santa Clara, CA (US)

(72) Inventors: Junyuan WANG, Shanghai (CN); Maksim LUKOSHKOV, Clarecastle (IE); Weigang LI, Shanghai (CN); Xin ZENG, Shanghai (CN)

(21) Appl. No.: 18/647,547

(22) Filed: Apr. 26, 2024

(30) Foreign Application Priority Data
Mar. 29, 2024 (WO) PCT/CN2024/084680

(51) Int. Cl. G06F 13/42

(52) U.S. Cl. CPC G06F 13/4221; G06F 2213/0024

(57) ABSTRACT

Techniques to improve device scalability using a peer-to-peer protocol over a communication link. The techniques can include use of an input/output (IO) device access instruction set architecture (ISA) command to place an IO job request through an agent device from a host processor to a device, the host processor, agent device and device coupled to a communication link switch. The IO job request can be communicated through the communication link switch.

### TECHNICAL FIELD

Examples described herein are generally related to improve device scalability using a peer-to-peer protocol over a communication link such as a Compute Express Link (CXL) communication link.

### BACKGROUND

Data centers based on disaggregated architectures are expected to be the most common types of data centers in the future. Disaggregated architectures, for example, can include offloading of and/or requesting data processing services from one or more applications supported by a host processor or a host central processing unit (CPU) to a device such as an accelerator device or a network interface controller (NIC) with at least some data processing capabilities (e.g., a smart NIC). The data processing services can include, for example, compression/decompression services, crypto-related (e.g., encryption/decryption) services, or database search services. The host processor or host CPU can be communicatively coupled with devices included in disaggregated architectures through a type of communication link or communication fabric capable of supporting multiple protocols. The type of communication link or communication fabric can be arranged to operate as described in a technical specification such as a technical specification coordinated by the Compute Express Link (CXL) Consortium, entitled the CXL Specification, Revision 3.1, published in August 2023, hereinafter referred to as “the CXL specification”.

### BRIEF DESCRIPTION OF THE DRAWINGS

FIG. 1 illustrates an example system.

FIG. 2 illustrates an example view of components of the system.

FIG. 3 illustrates an example enqueue command/enqueue command supervisor (ENQCMD(S)) format.

FIG. 4 illustrate an example job descriptor hierarchy.

FIG. 5 illustrates an example work flow.

FIG. 6 illustrates an example service chaining scheme.

FIG. 7 illustrates an example logic flow.

FIG. 8 illustrates an example storage medium.

FIG. 9 illustrates an example IO device access agent.

### DETAILED DESCRIPTION

In some examples, in order to facilitate a cloud native architecture, a set of relatively new instruction set architecture (ISA) commands have been proposed for use in host processors or host CPUs designed by Intel® Corporation. This set of relatively new ISA commands for general input/output (IO) device access that includes an enqueue command (ENQCMD) and an enqueue command supervisor (ENQCMDS), collectively hereinafter referred to as ENQCMD(S). IO device access ISA commands such as an ENQCMD(S) ISA command can allow both user space and kernel space application clients supported by a host processor or host CPU to submit IO job requests to a target Peripheral Component Interconnect (PCI) endpoint or device coupled with the host processor or host CPU, for example, via communication links routed through a fabric switch that can be configured to operate according to the CXL specification. Using an IO device access ISA command such as an ENQCMD(S) ISA command, the IO job requests can be submitted via an abstracted job descriptor included in the IO device access ISA command. Targeted PCI endpoints or devices can be arranged to reserve specific address windows (e.g., one for user space, and another for kernel space) for accessing IO device access ISA command information, and device driver(s) for the targeted PCI endpoints or devices can map at least portions of the reserved specific address windows to an applications' memory space. Client applications can then submit IO job requests via an IO device access ISA command directly to a targeted PCI endpoint or device.

According to some examples, on the PCI endpoint or device side of an IO job request, shared virtual memory (SVM) capabilities and a shared work queue (SWQ) asset have been introduced. SWQ can be built on top of a PCI endpoint's or device's hardware work queue (WQ), and can allow multiple services/processes associated with applications supported by host processors or host CPUs to submit IO job requests simultaneously. The use of SWQs can therefore remove a hardware WQ number limitation and can allow one PCI endpoint or device to be scaled out to support multiple services/processes (e.g., thousands of micro-services running on one server).

In some examples, another way to improve a PCI endpoint's or device's scalability, a device virtualization technology can be employed. For example, single root IO virtualization (SR-IOV) or Intel® scalable IO virtualization (sIOV). Also, a user queue (UQ) capability on a PCI endpoint or device can be configured to facilitate use of IO device access ISA commands for receiving IO job requests from applications supported by host processors or host CPUs arranged to handle IO job requests via IO device access ISA commands such as ENQCMD(S) ISA commands. For example, Intel® QuickAssist Technology (QAT) and Intel® Data Streaming Accelerator (DSA) accelerators can be configured to respond to ENQCMD(S) ISA commands and have enabled UQ features, on device, to support multiple services/processes associated with IO job requests. However, these ways to improve a PCI endpoint's or device's scalability related to SR-IOV and sIOV can be limited by available hardware resources at the PCI endpoints or devices. For example, SR-IOV is limited to a number of virtual functions (VFs) supported by hardware resources at the PCI endpoints or devices and sIOV is limited by a number of WQs at the PCI endpoints or devices. Also, UQ features on a PCI endpoint or device can be associated with extra implementation costs due to a need to support SWQs, support an ENQCMD(S) access window, or support SVM and an SVM's associated need for virtual-to-physical (V2P) address translation.

As described in more detail below, logic and/or features of circuitry of an IO device access agent coupled with a host processor or host CPU via communication links routed through a fabric switch can be arranged as a dedicated PCI endpoint or can be part of a PCI endpoint or device. The IO device access agent can have UQ enabled features arranged to handle IO device access ISA command requests issued from applications supported by the host processor or host CPU and can also be configured to forward potentially pre-processed data requests to targeted PCI endpoint(s) or device(s) also coupled to the fabric switch via separate communication links. Also, as described in more detail below, the communication links and the fabric switch can be configured to operate according to the CXL specification and CXL peer-to-peer (P2P) communication protocols can be used to forward the potentially pre-processed data requests to targeted PCI endpoint(s) or device(s) that have been configured to operate within a same or specific CXL virtual hierarchy (VH) as the IO device access agent.

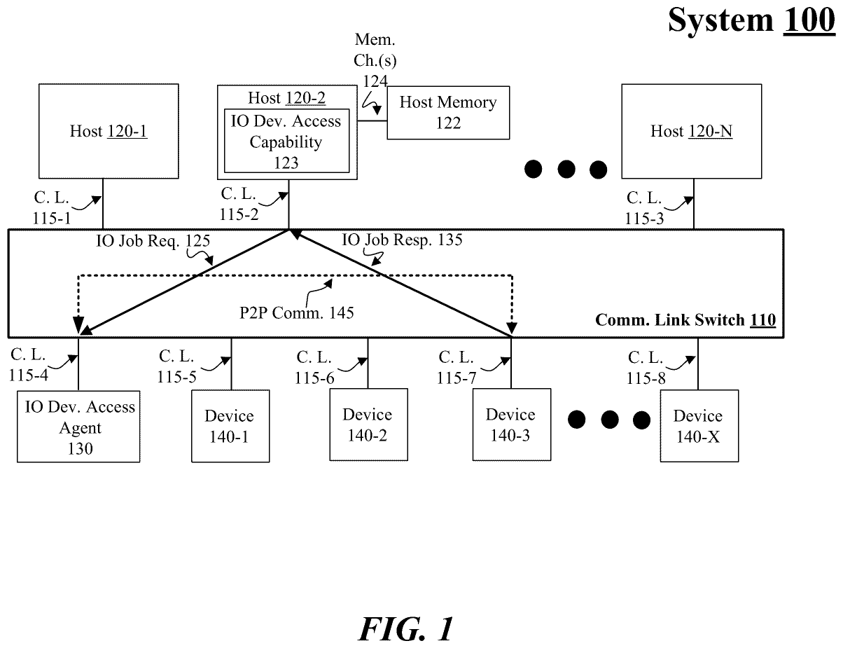

FIG. 1 illustrates an example system 100. In some examples, as shown in FIG. 1, system 100 includes a fabric or communication link switch 110 coupled with hosts 120-1 to 120-N via respective communication links 115-1 to 115-3, where “N” is any whole, positive integer greater than 2. Also, as shown in FIG. 1, communication link switch 110 can couple with IO device access agent 130 and devices 140-1 to 140-X via respective communication links 115-4 to 115-8, where “X” is any whole, positive integer greater than 3. For these examples, communication link switch 110, communication links 115-1 to 115-8, hosts 120-1 to 120-N, IO device access agent 130, and devices 140-1 to 140-X can be configured to operate according to the CXL specification and can be arranged to utilize CXL communication protocols to include, but not limited to, CXL.io, CXL.mem, CXL.cache, or CXL direct P2P communication protocols such as P2P.mem or P2P.io.

According to some examples, hosts 120-1 to 120-N can be host processors or host CPUs arranged to separately support one or more client applications. For ease of simplicity, only host 120-2 is shown as being coupled to a host memory 122 via one or more memory channels 124. The other hosts shown in FIG. 1 can also be coupled to their own respective host memory devices. Also, for ease of simplicity, only host 120-2 is shown as having an IO device access capability 123, the other hosts may or may not have this capability. For these examples, IO device access capability 123 can utilize ISA commands such as ENQCMD(S) to allow both user space and kernel space applications supported by host 120-2 to submit IO job requests to one or more targeted devices that can include IO device access agent 130 or a device from among devices 140-1 to 140-X via job descriptor information included in the IO device access ISA command. IO device access capability 123 can also allow IO device access agent 130 to reserve an address window associated with memory addresses for memory devices included in host memory 122 (e.g., dynamic random access memory (DRAM) memory devices) for accessing job descriptor information included in issued ISA commands such as ENQCMD(S) ISA commands to targeted devices coupled to host 120-2 through communication link switch 110. Although not shown in FIG. 1, host 120-2 can include a one or more device drivers arranged to map respective portions of the reserved specific address windows to an applications' memory space in order for the applications to submit IO job requests via an IO device access ISA command.

In some examples, devices 140-1 to 140-X can include CXL type 1, type 2 or type 3 devices. For example, CXL type 1 or type 2 accelerator devices such as, but not limited to Intel® QAT or DSA accelerators or general processing graphics processing units (GP-GPUs) arranged to process data associated with IO job requests submitted by applications supported by hosts 120-1 to 120-N. In other examples, devices 140-1 to 140-X can include CXL type 1 or type 2 devices such as, but not limited to, smart NICs. In other examples, devices 140-1 to 140-X can include CXL type 3 devices such as, but not limited to, solid state drives (SSDs) or pooled DRAM devices included in one or more dual in-line memory modules (DIMMs).

According to some examples, host 120-2, IO device access agent 130, and at least device 140-3 can be configured to be included in a same CXL virtual hierarchy (VH) having respective communication links 115-2, 115-4 and 115-7 routed through communication link switch 110. This same CXL VH can be configured, for example, as described in the CXL specification for configuration of a VH through a fabric switch. As part of the of the same CXL VH, as described more below, logic and/or features of circuitry of IO device access agent 130 can be arranged to use CXL direct P2P communication protocols to forward potentially pre-processed data requests included in an IO job request submitted via an IO device access ISA command targeted to device 140-3. For example, as shown in FIG. 1, an IO job request 125 can be submitted from an application supported by host 120-2 that targets device 140-3. The IO job request 125 can cause the logic and/or features of IO device access agent 130 to access job descriptor information included in an IO device access ISA command generated by the application (e.g., included in address window portion assigned to the application) and then generate a device-specific job descriptor and send that device-specific job descriptor to device 140-3 via a P2P communication 145 routed through communication link switch 110, e.g., using CXL direct P2P.mem protocols described in the CXL specification. Device 140-3 can then execute or fulfill IO job request 125 based on the device-specific job descriptor and then send a IO job response 135 to host 120-2 through communication link switch 110 based on information included in the device-specific job descriptor. IO device access agent 130, in response to the IO device access ISA command can enable device 140-3 to fulfill IO job request 125 without needing to support IO device access capabilities such as ENQCMD(S) capabilities or to support user queue (UQ) features.

According to some examples, host memory 122 can include any combination of volatile or non-volatile memory. For these examples, the volatile and/or non-volatile memory included in host memory 122 can be arranged to operate in compliance with one or more of a number of memory technologies described in various standards or specifications, such as DDR3 (double data rate version 3), JESD79-3F, originally released by JEDEC in July 2012, DDR4 (DDR version 4), JESD79-4C, originally published in January 2020, DDR5 (DDR version 5), JESD79-5B, originally published in September 2022, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published in June 2021, WIO2 (Wide Input/output version 2), JESD229-2, originally published in August 2014, HBM (High Bandwidth Memory), JESD235B, originally published in December 2018, HBM2 (HBM version 2), JESD235D, originally published in January 2020, or HBM3 (HBM version 3), JESD238A, originally published in January 2023, or other memory technologies or combinations of memory technologies, as well as technologies based on derivatives or extensions of such above-mentioned specifications. The JEDEC standards or specifications are available at www.jedec.org.

Volatile types of memory may include, but are not limited to, random-access memory (RAM), Dynamic RAM (DRAM), DDR synchronous dynamic RAM (DDR SDRAM), GDDR, HBM, static random-access memory (SRAM), thyristor RAM (T-RAM) or zero-capacitor RAM (Z-RAM). Non-volatile types of memory may include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

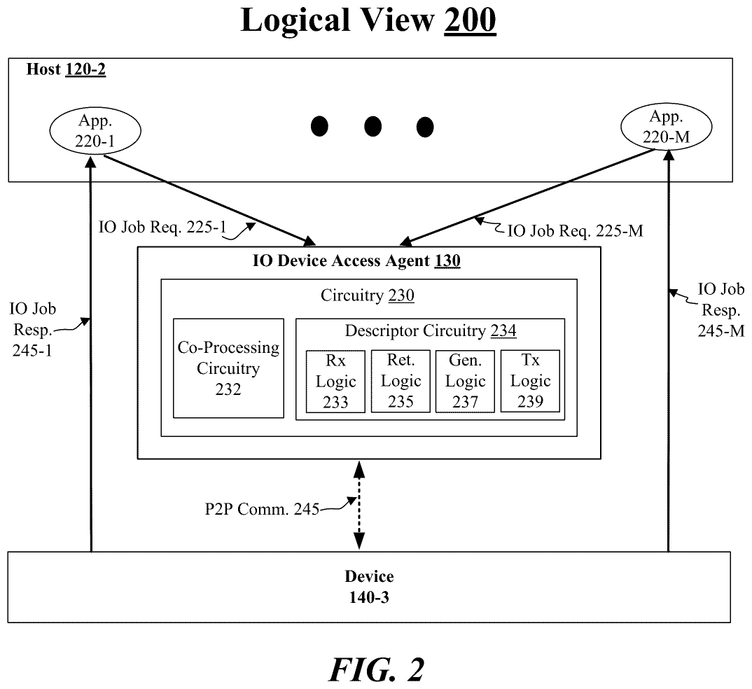

FIG. 2 illustrates an example logical view 200. In some examples, logical view 200 can be associated with a logical view of an example operation of elements of system 100 such as elements of host 120-2, IO device access agent 130 and device 140-3 in association with handling IO device access ISA commands (e.g., ENQCMD(S) ISA commands) targeted to device 140-3. For these examples, as shown in FIG. 2, IO device access agent 130 can include circuitry 230 that further includes a co-processing circuitry 232 and a descriptor circuitry 234 having a receive (Rx) logic 233, a retrieve logic 235, a generate logic 237 and a transmit (Tx) logic 239. Also, in some examples, IO device access agent 130 can be implemented as a hardware module that can be integrated into a package or system-on-a-chip (SoC) that also includes host 120-2 and can utilize co-processing circuitry 232 to work as a CXL co-processor on the host side of a VH arranged according to the CXL specification, the VH to also include target device 140-3. Alternatively, IO device access agent 130 can be implemented as a discrete CXL device, which can be deployed, for example, as a discrete PCI express (PCIe) card coupled to host 120-2 and device 140-3 through communication link switch 110.

According to some examples, as shown in FIG. 2, host 120-2 can be configured to support a plurality of applications 220-1 to 220-M, where “M” is any whole, positive integer greater than 1. SVM memory spaces for respective applications 220-1 to 220-M can be mapped to separate portions of the address window reserved by IO device access agent 130 to retrieve job descriptor information included in IO device access ISA commands issued by applications 220-1 to 220-M (e.g., included in host memory 120). For these examples, application 220-1 can submit a first IO job request 225-1 and application 220-M can submit a second IO job request 225-M (e.g., via separate IO device access ISA commands). An indication or detection of a IO job request 225-1 and 225-M can be received/detected by logic and/or features of descriptor circuitry 234 of IO device access agent 130 such as Rx logic 233. Logic and/or features of descriptor circuitry 234 such as retrieve logic 235 can access separate address spaces for job descriptor information associated with respective IO job requests 225-1 and 225-M (e.g., maintained in the separate portions of the reserved address window). Logic and/or features of descriptor circuitry 234 such as generate logic 237 can then generate separate device-specific descriptors based on the job descriptor associated with respective IO job requests 225-1 and 225-M that separately indicate that device 140-3 is the target device for the respective IO job requests and to include information for the IO job requested. Logic and/or features of descriptor circuitry 234 such as Tx logic 239 can then cause the separate device-specific descriptors to be sent to targeted device 140-3 via P2P communication 245 routed through communication link switch 110, e.g., using CXL direct P2P protocols such as, but not limited to, direct P2P.mem or direct P2P.io protocols. Targeted device 140-3, upon fulfillment of IO job request 225-1 can send an IO job response 245-1 to application 220-1 through communication link switch 110 and upon fulfillment of IO job request 225-M can send an IO job response 245-M to application 220-M also through communication link switch 110.

In some examples, circuitry 230 can include processor circuitry (e.g., CPU or graphics processing unit), one or more field programmable gate arrays (FPGAs), one or more application specific integrated chips (ASICs) or a combination of processor circuitry, FPGAs or ASICs. For example, co-processing circuitry 232 included in circuitry 230 can be processor circuitry and descriptor circuitry 234 can be an FPGA or an ASIC. In other examples, circuitry 230 can be a single processor circuitry, FPGA or ASIC and co-processing circuitry 232 and descriptor circuitry 234 can be separate portions of this single processor circuitry, FPGA or ASIC.

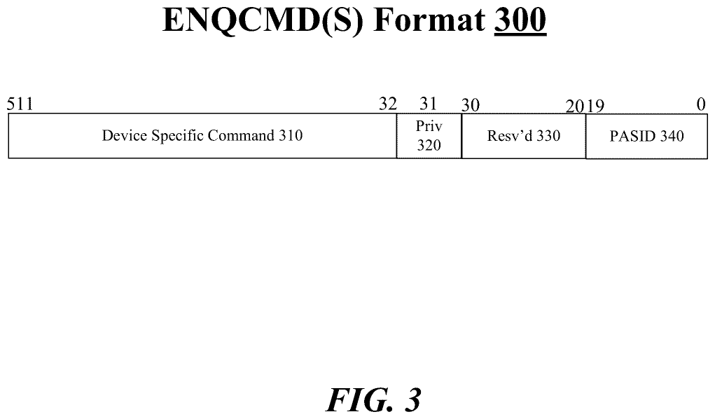

FIG. 3 illustrates an example ENQCMD(S) format 300. In some examples, ENQCMD(S) format 300 can be for either an Intel® ISA Enqueue Command or for an Intel® Enqueue Command Supervisor as described in the Intel® Architecture Instruction Set Extensions and Future Features Programming Reference published in March 2020. As mentioned in this Intel reference, one difference between Enqueue Command ENQCMD and Enqueue Command Supervisor (ENQCMDS) is that ENQCMDS ISA commands formats its source data differently from ENQCMD ISA commands. Specifically, ENQCMDS ISA commands formats its source data into command data. These two ISA commands are examples of IO device access ISA commands and can be referred to as ENQCMD(S) ISA commands. ENQCMD(S) ISA commands can allow system software to write commands to enqueue registers (e.g., maintained at a host processor or host CPU), which can be special device registers accessed using memory-mapped IO (MMIO). Enqueue registers at ENQCMD(S) capable host CPUs can expect writes to have the format of ENQCMD(S) format 300 shown in FIG. 3.

According to some examples, as shown in FIG. 3, ENQCMD(S) format 300 can includes 512 bits or 64 bytes of information partitioned into a device specific command 310, a privilege 320, a reserved 330 and a process address-space identifier (PASID) 340. For these examples, PASID 340 includes bits [19:0] and can indicate a source operand that was read from memory. The bits included in PASID 340 communicate a PASID that can be assigned to an application supported by the host processor or host CPU having an EMQCMD(S)/IO device access capability (e.g., host 120-2). Bits [30:20] included in reserved 330 are reserved and can be entered, for example, with bit values of 0. Bit included in privilege 320 can indicate whether the application or requesting service is a user, bit value=0, or a supervisor, bit value=1. Bits [511:32] of device specific command 310 can include a source operand that can be written to (e.g., by an application) and read from (e.g., by an IO device access agent) a reserved address window (e.g., maintained in a host memory). The source operand included in device specific command 310 can include information to enable a device such as IO device access agent 130 to access job descriptor information associated with, for example, an IO job request submitted via issuance of an ENQCMD(S) ISA command formatted according to example ENQCMD(S) format 300.

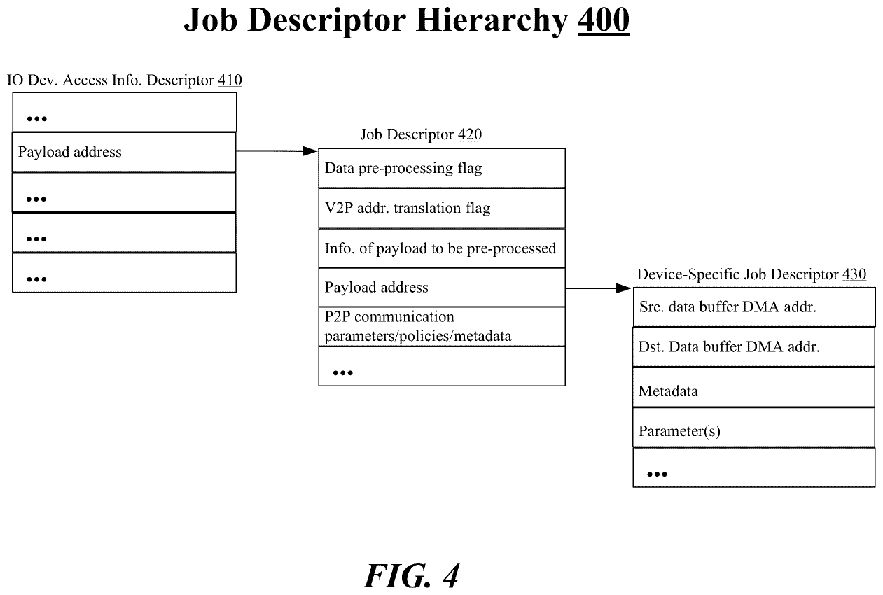

FIG. 4 illustrates an example job descriptor hierarchy 400. In some examples, job descriptor hierarchy 400 provides an example of a job descriptor hierarchy to communicate, for example, an IO job request to a target device (e.g., device 140-3) coupled with an IO device access/ENQCMD(S) capable host CPU (e.g., host 120-2) through a CXL switch (e.g., communication link switch 110). For these examples, the CXL switch can be configured to have the IO device access/ENQCMD(S) capable host CPU, the target device and an IO device access agent (e.g., IO device access agent 130) in a same virtual hierarchy (VH) to enable CXL direct P2P communications between at least the IO device access agent and the target device. Also, the IO device access agent can have access to an address window associated with memory addresses for memory devices included in a host memory of the host CPU (e.g., host memory 120) for accessing job descriptor information included in an issued IO device access ISA command to the targeted device, the issued IO device access ISA command to be associated with the IO job request.

In some examples, as shown in FIG. 4, IO device access information descriptor 410 can be a first level of job descriptor hierarchy 400. For these examples, IO device access information descriptor 410 can include, among other information not shown, a payload address. The payload address can indicate a virtual memory address associated with a shared virtual memory (SVM) address space utilized by the application to facilitate the requesting and execution of the IO job request made to the targeted device. The payload address, for example, may include pointers to virtual memory addresses that map to physical addresses include in a host memory of a host CPU that supports the application that made the IO job request. Examples are not limited to the information shown in FIG. 4 and mentioned above for IO device access information descriptor 410.

According to some examples, as shown in FIG. 4, job descriptor 420 can be a second level of job descriptor hierarchy 400. For these examples, the information included in job descriptor 420 can be generated based on job descriptor information abstracted from the payload address included in IO device access information descriptor 410. Job descriptor 420 can include a data pre-processing flag to indicate that at least some data pre-processing is to done by co-processing circuitry of the IO device access agent (e.g., data compression). Abstracted job descriptor 420 can also include a V2P address translation flag to indicate, for example, that a virtual-to-physical address translation is needed for translating virtual addresses abstracted from the payload address included in IO device access information descriptor 410. In other words, the targeted device can lack a capability to implement V2P address translation for the SVM address space of the application that placed the IO job request. Job descriptor 420 can also include information of payload to be pre-processed if the data pre-processing flag is asserted. The information of the payload to be pre-processed can include what type of pre-processing is requested such as, but not limited to compression, decompression or crypto-related pre-processing. Job descriptor 420 can also include a payload address associated with the SVM address space utilized by the application making the job request. If the V2P address translation flag is asserted, a V2P address translation is performed and the indicated payload address can correspond to a physical memory address at the host memory of the host CPU supporting the application, otherwise a virtual memory address is provided under a presumption that the targeted device is capable of performing the V2P address translation. Job descriptor 420 can also include P2P communication parameters/policies/metadata to facilitate the IO device access agent's ability to send information associated with the IO job request to the targeted device using CXL direct P2P protocols such as, but not limited to, CXL direct P2P.mem or P2P.io protocols. Examples are not limited to the information shown in FIG. 4 and mentioned above for job descriptor 420.

According to some examples, as shown in FIG. 4, device-specific job descriptor 430 can be a third level of job descriptor hierarchy 400. For these examples, device-specific job descriptor 430 can include a source data buffer DMA address that indicates an address to pull data to be processed in association with the IO job request via a direct memory access (DMA) by the targeted device. For example, the source data buffer DMA address can include lower and upper request base pointers to first memory addresses for the host memory of the host CPU supporting the application making the IO job request. Device-specific job descriptor 430 can also include a destination data buffer DMA address that indicates an address to place data that was processed by the targeted device in association with the IO job request via a DMA by the targeted device. For example, the destination data buffer DMA address can include lower and upper response base pointers to second memory addresses for the host memory. Device-specific job descriptor 430 can also include metadata information to facilitate execution of the IO job request such as, but not limited to, priority information, class of service information, service level agreement information, security information, etc. Device-specific job descriptor 430 can also include parameter(s) information associated with the IO job request. Parameter(s) information can include one or more operating parameters associated with executing the IO job request (e.g., maximum time to execute the IO job request, memory bandwidth required, etc.). Examples are not limited to the information shown in FIG. 4 and mention above for device-specific job descriptor 430.

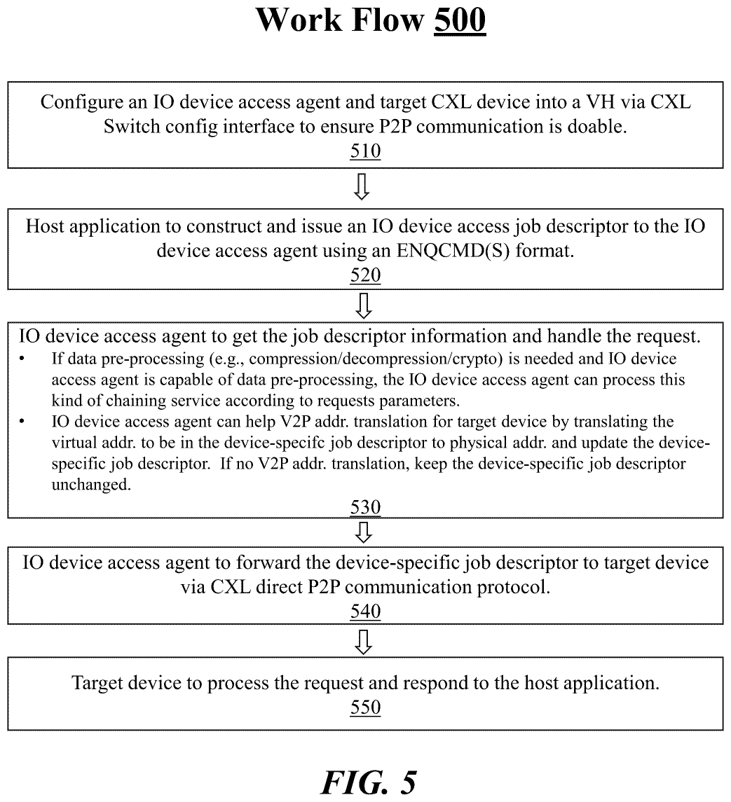

FIG. 5 illustrates example work flow 500. In some examples, work flow 500 can be an example work flow for IO job request issued by an application supported by a host processor or host CPU that targets a CXL device and utilizes an IO device access agent to facilitate handling and possibly some portion of the execution of the IO job request. For these examples, the host processor or host CPU, IO device access agent and targeted device can be coupled through a communication link switch configured in accordance with the CXL specification that includes the host processor or host CPU, IO device access agent and targeted device being configured such that they are included in a same VH that enables CXL direct P2P communications. Work flow 500, for example, can be implemented by components of system 100 shown in FIG. 1 or in logical view 200 shown in FIG. 2 and can include the use of ENQCMD(S) format 300 shown in FIG. 3 or the job descriptor hierarchy 400 shown in FIG. 4.

According to some examples, work flow 500 at 510 can configure an IO device access agent and target CXL device into a VH via a CXL switch configuration interface to ensure P2P communication is doable. For these examples, a server user, a data center operator or cloud service provider can cause the IO device access agent and target CXL device to be configured such that they are in a same VH. For example, as shown in FIG. 2, host 120-2, IO device access agent 130 and device 140-3 can be configured to be in a same VH and can communicate via P2P communication 245 that can be routed through respective CXL switch configuration interfaces coupled with communication link switch 110.

In some examples, work flow 500 at 520 can include a host application to construct and issue an IO device access information job descriptor to the IO device access agent using an ENQCMD(S) format. For these examples, the ENQCMD(S) format can be ENQCMD(S) format 300 as shown in FIG. 3. Logic and/or features of circuitry of IO device access agent 130 such as Rx logic 233 of descriptor circuitry 234 can be configured to receive the IO device access information) job descriptor.

According to some examples, work flow 500 at 530 can include the IO device access agent to get the job descriptor information and handle the request. For example, logic and/or features of circuitry of IO device access agent 130 such as retrieve logic 235 of descriptor circuitry 234 can be configured to retrieve the job descriptor information. Also, if data pre-processing (e.g., compression/decompression/crypto) is needed and the IO device access agent is capable of data pre-processing, the IO device access agent can process this kind of chaining service according to request parameters. For example, co-processing circuitry 232 of IO device access agent 130 can be capable of preforming data pre-processing according to the request parameters. Also, the IO device access agent can help V2P address translation for the target device by translating the virtual address to be in the device-specific job descriptor to physical address and update the device-specific job descriptor. If no V2P address translation, keeps the device-specific job descriptor unchanged. For example, logic and/or features of circuitry of IO device access agent 130 such as generate logic 237 of descriptor circuitry 234 can help with the V2P address translation and to update the device-specific job descriptor.

In some examples, work flow 500 at 540 can include the IO device access agent to forward the device-specific job descriptor to target device via a CXL direct P2P communication protocol. For example, logic and/or features of circuitry of the IO device access agent such as Tx logic 239 of descriptor circuitry 234 can be configured to forward or transmit the device-specific job descriptor through the communication link switch 110 configured in accordance with the CXL specification.

According to some examples, work flow 500 at 550 can include the target device to process the request and respond to host application. For example, as shown in FIG. 2, device 140-3 can process IO job request 225-1 that originated from application 220-1 and was routed through IO device access agent 130 and respond back to application 220-1 via IO job response 245-1. Work flow 500 is then complete.

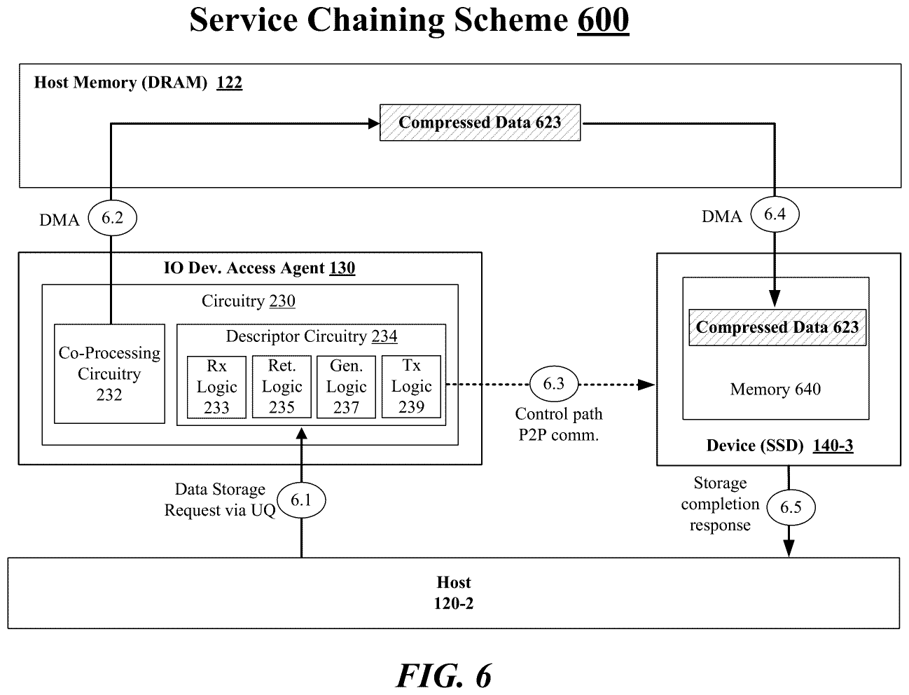

FIG. 6 illustrates an example service chaining scheme 600. According to some examples, service chaining scheme 600 shows an example of how an IO device access agent can participate in at least a portion of an IO job request issued by an application supported by a host. For these examples, as shown in FIG. 6, elements of system 100 shown in FIG. 1 such as host 120-2, host memory 122, IO device access agent 130 and device 140-3 and elements of IO device access agent 130 as shown in FIG. 2 such as logic and/or features of circuitry 230 as shown in FIG. 2 can implement at least portions of service chaining scheme 600. Examples are not limited to these elements of system 100 and/or IO device access agent 130. Although not shown in FIG. 6, host 120-2, IO device access agent 130 and device 140-3 can be coupled through communication link switch 110 that can be configured such that these elements of system 100 can be in a same VH to enable CXL direct P2P communications between at least IO device access agent 130 and device 140-3.

Beginning at 6.1, an application supported by host 120-2 can issue a data storage request directed to a user queue (UQ) asset at IO device access agent 130 that enables logic and/or features of descriptor circuitry 234 such as Rx logic 233 to receive the request and retrieve logic 235 to retrieve IO device access descriptor information through communication link switch 110 to obtain information associated with the data storage request (e.g., from a reserved address window associated with the application). The retrieved information can indicate that at least some pre-processing is to be executed by co-processing circuitry 232 on the data to be stored to targeted device 140-3. The pre-processing can include, for example, compressing the data before it is stored to device 140-3. For these examples, targeted device 140-3 can be a CXL type 3 solid state drive (SSD) that include a memory 640.

Moving to 6.2, co-processing circuitry 232 of IO device access agent 130 can compress the data to be stored to device 140-3 and then cause a DMA through communication link switch 110 to store compressed data 623 to host memory 122. In some examples, the descriptor information retrieved by retrieve logic 235 through communication link switch 110 can include memory address pointers to indicate where to obtain the data to compress and then what memory address to DMA to host memory 122 to place compressed data 623 in host memory 122.

Moving to 6.3, logic and/or features of descriptor circuitry 234 such as generate logic 237 can generate a device-specific descriptor to indicate to device 140-3 where to pull the compressed data 623 from host memory 122 and to then store compressed data 623 to memory 640 (e.g., includes non-volatile memory) at device 140-3 and also to indicate how to send a storage completion response to the requesting application (e.g., a destination data buffer address). Then, logic and/or features of descriptor circuitry 234 such as Tx logic 239 can cause the device-specific descriptor to be sent to device 140-3 via a control path P2P communication through communication link switch 110 that can utilize CXL direct P2P communication protocols.

Moving to 6.4, based on information in the device-specific descriptor, device 140-3 can obtain compressed data 623 from host memory 122 and cause a DMA of compressed data 623 to memory 640 at device 140-3 through communication link switch 110.

Moving to 6.5, also based on information in the device-specific descriptor, device 140-3 sends a completion response to the requesting application. The completion response can be sent through communication link switch 110. Service chaining scheme 600 then comes to an end.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

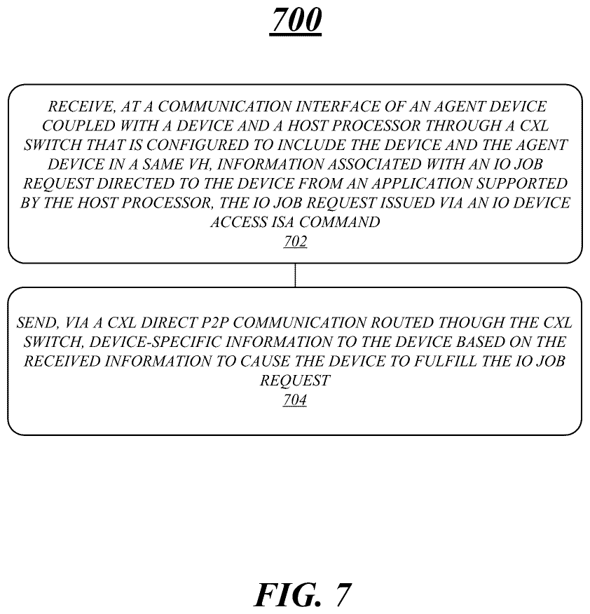

FIG. 7 illustrates an example logic flow 700. Logic flow 700 may be representative of some or all of the operations executed by one or more logic and/or features of circuitry at an agent device (e.g., IO device access agent 130) having a communication interface (e.g., operated according to the CXL specification) coupled with a device (e.g., device 140-3) and a host processor (e.g., host 120-2) through a CXL switch (e.g., communication link switch 110).

According to some examples, logic flow 700 at block 702 can receive, at a communication interface of an agent device coupled with a device and a host processor through a CXL switch that is configured to include the device and the agent device in a same VH, information associated with an IO job request directed to the device from an application supported by the host processor, the IO job request issued via an IO device access ISA command (e.g., an ENQCMD(S) ISA command).

In some examples, logic flow 700 at block 704 can send, via a CXL direct P2P communication routed though the CXL switch, device-specific information to the device based on the received information to cause the device to fulfill the IO job request.

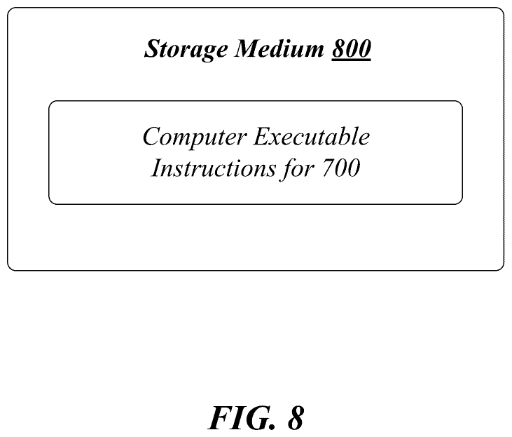

FIG. 8 illustrates an example of a storage medium. As shown in FIG. 8, the storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

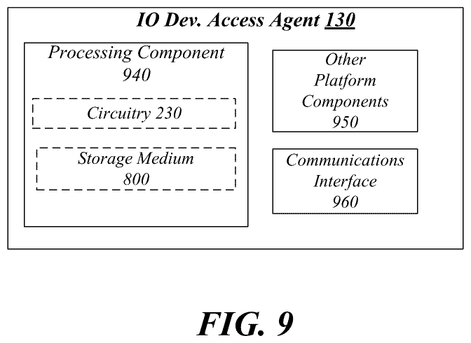

FIG. 9 illustrates an example of IO device access agent 130. In some examples, IO device access agent 130 shown in FIG. 9 depicts a system view that includes circuitry 230 and storage medium 800 as part of a processing component 940. For these examples, IO device access agent 130 can also include other components 950 and a communications interface 960.

According to some examples, as mentioned above, processing component 940 can include circuitry 230 and a storage medium such as storage medium 800. Processing component 940 can include various hardware elements, software elements, or a combination of both. Examples of hardware elements can be circuitry 230 that includes co-processing circuitry 232 and descriptor circuitry 234. Examples of software elements can include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given example.

In some examples, other components 950 can include, memory units, chipsets, controllers, interfaces, oscillators, timing devices, power supplies, and so forth. Examples of memory units can include without limitation various types of computer readable and machine readable storage media in the form of one or more higher speed memory units, such as read-only memory (ROM), RAM, DRAM, Double-Data-Rate DRAM (DDRAM), SDRAM, SRAM, programmable ROM (PROM), erasable programmable ROM (EPROM), electrically erasable programmable ROM (EEPROM), types of non-volatile memory. Other types of computer readable and machine readable storage media can also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 can include logic and/or features to support a communication interface. For example, to couple with a device (e.g., device 140-3) and a host processor (e.g., host 120-2) through a communication link switch (e.g., communication link switch 110). For these examples, communications interface 960 can include one or more communication interfaces that operate according to various communication protocols or standards to communicate over direct or network communication links or channels. Direct communications can occur via use of communication protocols or standards described in one or more industry standards (including progenies and variants) such as those associated with the PCIe specification or the CXL specification. Network communications can occur via use of communication protocols or standards such those described in one or more Ethernet standards promulgated by IEEE. For example, one such Ethernet standard can include IEEE 802.3. Network communication can also occur according to one or more OpenFlow specifications such as the OpenFlow Hardware Abstraction API Specification.

The components and features of IO device access agent 130 can be implemented using any combination of discrete circuitry, ASICs, logic gates and/or single chip architectures. Further, the features of IO device access agent 130 can be implemented using microcontrollers, programmable logic arrays and/or microprocessors or any combination of the foregoing where suitably appropriate. It is noted that hardware, firmware and/or software elements can be collectively or individually referred to herein as “circuitry”, “logic” or “feature.”

It should be appreciated that the example IO device access agent 130 shown in the block diagram of FIG. 9 can represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Although not depicted, any system or device can include and use a power supply such as but not limited to a battery, AC-DC converter at least to receive alternating current and supply direct current, renewable energy source (e.g., solar power or motion based power), or the like.

One or more aspects of at least one example may be implemented by representative instructions stored on at least one machine-readable medium which represents various logic within a processor, processor circuit, ASIC, or FPGA which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the processor, processor circuit, ASIC, or FPGA.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

Example 1. An example apparatus can include a communication interface to couple with a device and a host processor through a CXL switch. The CXL switch can be configured to include the device and the apparatus in a same VH. The apparatus can also include circuitry to receive information associated with an IO job request directed to the device from an application supported by the host processor. The IO job request can be issued via an IO device access ISA command. The circuitry can also be configured to send, via a CXL direct P2P communication routed through the CXL switch, device-specific information to the device based on the received information to cause the device to fulfill the IO job request.

Example 2. The apparatus of example 1, the IO device access ISA command can be an ENQCMD or an ENQCMDS.

Example 3. The apparatus of example 1, the circuitry can also be configured to perform a V2P translation of a virtual memory address included in the information associated with the IO job request to generate a physical memory address of a host memory coupled to the host processor. The circuitry can also include the physical memory address in the device-specific information.

Example 4. The apparatus of example 3, the physical memory address can be arranged to store data to be obtained by the device from the host memory through the CXL switch based on the information associated with the IO job request.

Example 5. The apparatus of example 1, the CXL direct P2P communication routed through the CXL switch can be based, at least in part, on a CXL direct P2P.mem communication protocol or a CXL direct P2P.io communication protocol.

Example 6. The apparatus of example 1 can also include co-processing circuitry configured to pre-process data indicated in the information associated with IO job request. The co-processing circuitry can also be configured to cause the pre-processed data to be stored to a memory address at a host memory coupled to the host processor. The device-specific information sent to the device indicates the memory address to enable the device to obtain the pre-processed data through the CXL switch.

Example 7. The apparatus of example 6, the co-processing circuitry to pre-process data can include the co-processing circuitry to compress the data, decompress the data, encrypt the data, or decrypt the data.

Example 8. The apparatus of example 7, comprising the co-processing circuitry can also be configured to compress the data and the device comprises a storage device.

Example 9. An example method implemented at an agent device can include receiving, at a communication interface of the agent device coupled with a device and a host processor through a CXL switch that is configured to include the device and the agent device in a same VH, information associated with an IO job request directed to the device from an application supported by the host processor. The IO job request can be issued via an IO device access ISA command. The method can also include sending, via a CXL direct P2P communication routed though the CXL switch, device-specific information to the device based on the received information to cause the device to fulfill the IO job request.

Example 10. The method of example 9, the IO device access ISA command can be an ENQCMD or an ENQCMDS.

Example 11. The method of example 9 can also include performing a V2P translation of a virtual memory address included in the information associated with IO job request to generate a physical memory address of a host memory coupled to the host processor. The method can also include including the physical memory address in the device-specific information.

Example 12. The method of example 11, the physical memory address can be arranged to store data to be obtained by the device from the host memory through the CXL switch based on the information associated with the IO job request.

Example 13. The method of example 9, the CXL direct P2P communication routed through the CXL switch can be based, at least in part, on a CXL direct P2P.mem communication protocol or a CXL direct P2P.io communication protocol.

Example 14. The method of example 9, can also include pre-processing data indicated in the information associated with IO job request and causing the pre-processed data to be stored to a memory address at a host memory coupled to the host processor. The device-specific information sent to the device can indicate the memory address to enable the device to obtain the pre-processed data through the CXL switch.

Example 15. An example at least one non-transitory computer-readable storage medium can include a plurality of instructions, that when executed by an agent device, can cause circuitry at agent device to receive, at a communication interface of the agent device coupled with a device and a host processor through a CXL switch that is configured to include the device and the agent device in a same VH, information associated with an IO job request directed to the device from an application supported by the host processor, the IO job request issued via an IO device access ISA command. The instructions can also cause the agent device to send, via a CXL direct peer-to-peer (P2P) communication routed though the CXL switch, device-specific information to the device based on the received information to cause the device to fulfill the IO job request.

Example 16. The at least one non-transitory computer-readable storage medium of example 15, the IO device access ISA command cab be an ENQCMD or an ENQCMDS.

Example 17. The at least one non-transitory computer-readable storage medium of example 15, the instructions can also cause the circuitry at the agent device to perform a V2P translation of a virtual memory address included in the information associated with IO job request to generate a physical memory address of a host memory coupled to the host processor. The instructions can also cause the agent device to include the physical memory address in the device-specific information.

Example 18. The at least one non-transitory computer-readable storage medium of example 17, the physical memory address can be arranged to store data to be obtained by the device from the host memory through the CXL switch based on the information associated with the IO job request.

Example 19. The at least one non-transitory computer-readable storage medium of example 15, the CXL direct P2P communication routed through the CXL switch can be based, at least in part, on a CXL direct P2P.mem communication protocol or a CXL direct P2P.io communication protocol.

Example 20. The at least one non-transitory computer-readable storage medium of example 15 can also include the instructions to cause the circuitry at the agent device to pre-process data indicated in the information associated with IO job request. The instructions can also cause the agent device to cause the pre-processed data to be stored to a memory address at a host memory coupled to the host processor. The device-specific information sent to the device can indicate the memory address to enable the device to obtain the pre-processed data through the CXL switch.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a communication interface to couple with a device and a host processor through a Compute Express Link (CXL) switch, the CXL switch configured to include the device and the apparatus in a same virtual hierarchy (VH); and
circuitry to:
receive information associated with an input/out (IO) job request directed to the device from an application supported by the host processor, the IO job request issued via an IO device access instruction set architecture (ISA) command; and
send, via a CXL direct peer-to-peer (P2P) communication routed through the CXL switch, device-specific information to the device based on the received information to cause the device to fulfill the IO job request.

2. The apparatus of claim 1, wherein the IO device access ISA command comprises an enqueue command (ENQCMD) or an enqueue command supervisor (ENQCMDS).

3. The apparatus of claim 1, further comprising the circuitry to:
perform a virtual-to-physical (V2P) translation of a virtual memory address included in the information associated with the IO job request to generate a physical memory address of a host memory coupled to the host processor; and
include the physical memory address in the device-specific information.

4. The apparatus of claim 3, wherein the physical memory address is to be arranged to store data to be obtained by the device from the host memory through the CXL switch based on the information associated with the IO job request.

5. The apparatus of claim 1, wherein the CXL direct P2P communication routed through the CXL switch is based, at least in part, on a CXL direct P2P.mem communication protocol or a CXL direct P2P.io communication protocol.

6. The apparatus of claim 1, further comprising:
co-processing circuitry to:
pre-process data indicated in the information associated with IO job request; and
cause the pre-processed data to be stored to a memory address at a host memory coupled to the host processor, wherein the device-specific information sent to the device indicates the memory address to enable the device to obtain the pre-processed data through the CXL switch.

7. The apparatus of claim 6, wherein the co-processing circuitry to pre-process data comprises to compress the data, decompress the data, encrypt the data, or decrypt the data.

8. The apparatus of claim 7, comprising the co-processing circuitry to compress the data and the device comprises a storage device.

9. A method implemented at an agent device comprising:
receiving, at a communication interface of the agent device coupled with a device and a host processor through a Compute Express Link (CXL) switch that is configured to include the device and the agent device in a same virtual hierarchy (VH), information associated with an input/out (IO) job request directed to the device from an application supported by the host processor, the IO job request issued via an IO device access instruction set architecture (ISA) command; and
sending, via a CXL direct peer-to-peer (P2P) communication routed though the CXL switch, device-specific information to the device based on the received information to cause the device to fulfill the IO job request.

10. The method of claim 9, wherein the IO device access ISA command comprises an enqueue command (ENQCMD) or an enqueue command supervisor (ENQCMDS).

11. The method of claim 9, further comprising:
performing a virtual-to-physical (V2P) translation of a virtual memory address included in the information associated with IO job request to generate a physical memory address of a host memory coupled to the host processor; and
including the physical memory address in the device-specific information.

12. The method of claim 11, wherein the physical memory address is to be arranged to store data to be obtained by the device from the host memory through the CXL switch based on the information associated with the IO job request.

13. The method of claim 9, wherein the CXL direct P2P communication routed through the CXL switch is based, at least in part, on a CXL direct P2P.mem communication protocol or a CXL direct P2P.io communication protocol.

14. The method of claim 9, further comprising:
pre-processing data indicated in the information associated with IO job request; and
causing the pre-processed data to be stored to a memory address at a host memory coupled to the host processor, wherein the device-specific information sent to the device indicates the memory address to enable the device to obtain the pre-processed data through the CXL switch.

15. At least one non-transitory computer-readable storage medium, comprising a plurality of instructions, that when executed by an agent device, cause circuitry at agent device to:
receive, at a communication interface of the agent device coupled with a device and a host processor through a Compute Express Link (CXL) switch that is configured to include the device and the agent device in a same virtual hierarchy (VH), information associated with an input/out (IO) job request directed to the device from an application supported by the host processor, the IO job request issued via an IO device access instruction set architecture (ISA) command; and
send, via a CXL direct peer-to-peer (P2P) communication routed though the CXL switch, device-specific information to the device based on the received information to cause the device to fulfill the IO job request.

16. The at least one non-transitory computer-readable storage medium of claim 15, wherein the IO device access ISA command comprises an enqueue command (ENQCMD) or an enqueue command supervisor (ENQCMDS).

17. The at least one non-transitory computer-readable storage medium of claim 15, further comprising the instructions to cause the circuitry at the agent device to:
perform a virtual-to-physical (V2P) translation of a virtual memory address included in the information associated with IO job request to generate a physical memory address of a host memory coupled to the host processor; and
include the physical memory address in the device-specific information.

18. The at least one non-transitory computer-readable storage medium of claim 17, wherein the physical memory address is to be arranged to store data to be obtained by the device from the host memory through the CXL switch based on the information associated with the IO job request.

19. The at least one non-transitory computer-readable storage medium of claim 15, wherein the CXL direct P2P communication routed through the CXL switch is based, at least in part, on a CXL direct P2P.mem communication protocol or a CXL direct P2P.io communication protocol.

20. The at least one non-transitory computer-readable storage medium of claim 15, further comprising the instructions to cause the circuitry at the agent device to:
pre-process data indicated in the information associated with IO job request; and
cause the pre-processed data to be stored to a memory address at a host memory coupled to the host processor, wherein the device-specific information sent to the device indicates the memory address to enable the device to obtain the pre-processed data through the CXL switch.
